(19) United States
(12) Patent Application Publication
(10) Pub. No.: US 2015/0242754 A1
(43) Pub. Date: Aug. 27, 2015

(54) PATTERN RECOGNITION SYSTEM, PATTERN RECOGNITION METHOD, AND COMPUTER PROGRAM PRODUCT

(71) Applicants: Hiroaki FUKUDA, Kanagawa (JP); Yohsuke MURAMOTO, Kanagawa (JP); Yasunobu SHIRATA, Tokyo (JP); Junichi TAKAMI, Kanagawa (JP)

(72) Inventors: Hiroaki FUKUDA, Kanagawa (JP); Yohsuke MURAMOTO, Kanagawa (JP); Yasunobu SHIRATA, Tokyo (JP); Junichi TAKAMI, Kanagawa (JP)

(73) Assignee: Ricoh Company, Limited, Tokyo (JP)

(21) Appl. No.: 14/618,603

(22) Filed: Feb. 10, 2015

(30) Foreign Application Priority Data
Feb. 26, 2014 (JP) 2014-035934

(51) Int. Cl. G06N 5/04; G06N 7/00; G06N 99/00

(52) U.S. Cl. CPC G06N 5/047; G06N 99/005; G06N 7/005

(57) ABSTRACT

A pattern recognition system includes a learning unit, a learning unit, a threshold calculation unit, and a determining unit. The learning unit learns, based on learned data of a first pattern, a model for determining whether recognition object data is the first pattern. The learning unit calculates likelihood indicating how likely the recognition object data is the first pattern by using the model learned by the learning unit. The threshold calculation unit calculates a threshold to be compared with the likelihood to determine whether the recognition object data is the first pattern, based on first likelihood that is calculated with respect to learned data of the first pattern and second likelihood that is calculated with respect to learned data of a second pattern. The determining unit determines whether the recognition object data is the first pattern by using the threshold.

### CROSS-REFERENCE TO RELATED APPLICATION(S)

The present application claims priority to and incorporates by reference the entire contents of Japanese Patent Application No. 2014-035934 filed in Japan on Feb. 26, 2014.

### BACKGROUND OF THE INVENTION

1. Field of the Invention

The present invention relates to a pattern recognition system, a pattern recognition method, and a computer program product.

2. Description of the Related Art

Technologies have been proposed that automatically detect abnormal sound occurring in machines by determining features of the abnormal sound. Technologies relating to pattern recognition have been proposed that learn specific sound as abnormal sound and determine that an abnormal event has occurred by detecting the abnormal sound from daily sound. Japanese Patent No. 5131863 discloses a method for detecting abnormal sound in which high-order local autocorrelation (HLAC) features are used to detect abnormal sound from acoustic features. A method for detecting abnormal sound using a Gaussian mixture model (GMM) is disclosed in Aiba Akihito, Ito Masashi, Ito Akinori, Makino Shozo, “Evaluation of Abnormal Sound Detection Using GMM in Daily Life Environment”, Proceedings of the Acoustical Society of Japan, March 2009, pp. 711-712.

Conventional abnormal sound detection systems learn both normal sound and abnormal sound in most cases on the assumption that the features of the normal sound largely differ from those of the abnormal sound. In other words, the conventional technologies do not assume various situations, such as a situation in which normal sound has many variations, a situation in which many variations of normal sound include normal sound having characteristics similar to those of abnormal sound, and a situation in which weak abnormal sound is buried in normal sound, in detecting abnormal sound. The conventional technologies, therefore, have difficulty in distinguishing abnormal sound from normal sound.

In Japanese Patent No. 5131863, for example, abnormal sound is detected based on a distance of deviation from normal sound. In Aiba et al., likelihood distribution of normal sound is only used in setting a threshold for separating normal sound from abnormal sound. These technologies have difficulty in distinguishing abnormal sound from normal sound in the various situations described above.

Therefore, there is a need to achieve pattern recognition with high accuracy.

### SUMMARY OF THE INVENTION

According to an embodiment, a pattern recognition system includes a learning unit, a learning unit, a threshold calculation unit, and a determining unit. The learning unit learns, based on learned data of a first pattern, a model for determining whether recognition object data is the first pattern. The learning unit calculates likelihood indicating how likely the recognition object data is the first pattern by using the model learned by the learning unit. The threshold calculation unit calculates a threshold to be compared with the likelihood to determine whether the recognition object data is the first pattern, based on first likelihood that is calculated with respect to learned data of the first pattern and second likelihood that is calculated with respect to learned data of a second pattern. The determining unit determines whether the recognition object data is the first pattern by using the threshold.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of a pattern recognition system according to a first embodiment of the present invention;

FIG. 2 is a block diagram illustrating an example of a functional configuration of a multifunction peripheral (MFP);

FIG. 3 is a flowchart illustrating an example of learning operation, threshold calculation operation, and recognition operation according to the first embodiment;

FIG. 4 is a diagram illustrating an example of the threshold calculation operation;

FIG. 5 is a block diagram illustrating an example of a configuration of a pattern recognition system according to a second embodiment of the present invention; and

FIG. 6 is a diagram illustrating a hardware configuration of a server according to the second embodiment.

### DETAILED DESCRIPTION OF THE PREFERRED EMBODIMENTS

Embodiments will be described below in detail with reference to the accompanying drawings. Although the following describes an example in which the pattern recognition system according to the present invention is applied to an abnormal sound detection system that recognizes (detects) abnormal sound of an image forming apparatus, the pattern recognition system can be applied to other systems than the abnormal sound detection system. For example, the pattern recognition system can be implemented by any devices (for example, image projection devices such as projectors, devices constituting a videoconference system, personal computers, and mobile phones) other than the image forming device in detecting abnormal sound. The pattern recognition system can be implemented in recognizing any patterns (for example, image patterns) other than abnormal sound.

The image forming apparatus may be, for example, a copier, a printer, a scanner, or a facsimile, and may be an MFP having at least two functions of the copier function, the printer function, the scanner function, and the facsimile function. The MFP has a plurality of functions and has many variations (kinds) of normal sound. According to the embodiments, even when there are many variations of normal sound in a device as described above, the device can distinguish abnormal sound from normal sound with high accuracy.

### First Embodiment

Many conventional technologies learn both normal sound and abnormal sound, as described above. In this case, when normal sound has many variations, normal sound similar to any kind of abnormal sound exists. Thus, recognition errors highly possibly occur in some cases in which certain abnormal sound is recognized as similar normal sound.

A pattern recognition system according to a first embodiment only learns a pattern (first pattern) that has relatively few variations, and does not learn a pattern (second pattern) that has relatively many variations. When the pattern recognition system is applied to an abnormal sound detection system, the system, for example, only learns abnormal sound, and does not learn normal sound. When abnormal sound has more variations than normal sound, the pattern recognition system may be configured to learn only normal sound and not to learn abnormal sound.

In the recognition process, recognition object data (i.e., data to be recognized) is first classified into any abnormal sound category. The recognition object data is determined as to whether the data is the abnormal sound in the category into which the data is classified (whether the data is normal sound) by comparing likelihood with a threshold. In the first embodiment, the threshold used for the comparison is calculated in advance by using learned data of normal sound and learned data of abnormal sound.

With this configuration, even in a situation such as a situation in which normal sound has many variations, in which many variations of the sound include normal sound having characteristics similar to those of abnormal sound, and in which weak abnormal sound is buried in normal sound, abnormal sound can be detected with high accuracy.

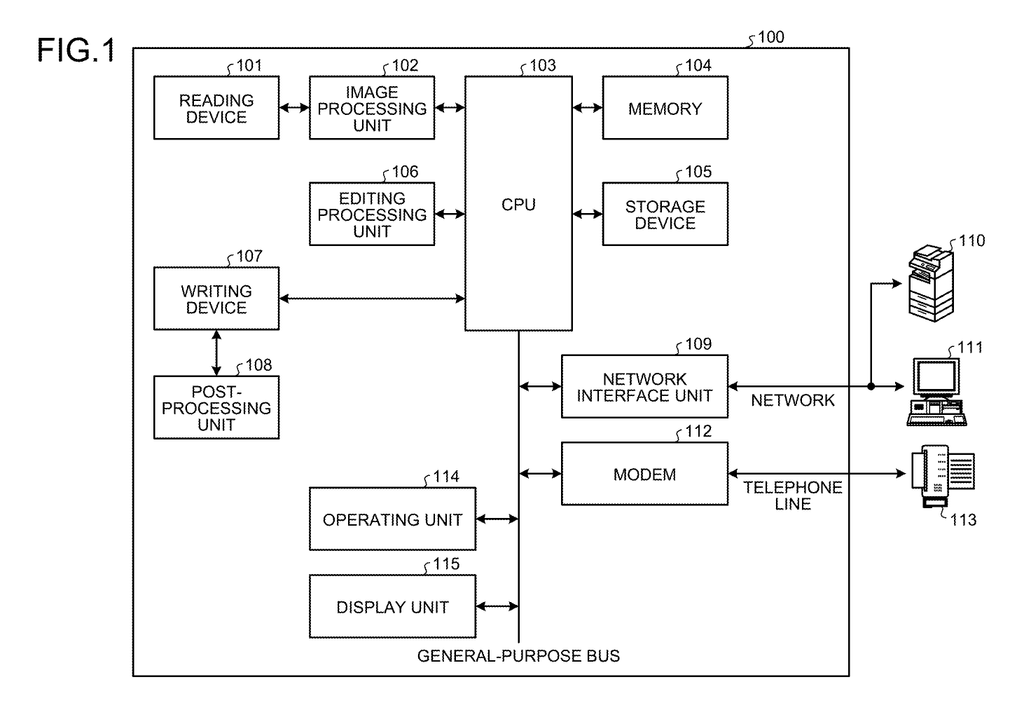

FIG. 1 is a block diagram illustrating a configuration of the pattern recognition system according to the first embodiment. As illustrated in FIG. 1, the pattern recognition system according to the first embodiment includes an MFP 100 that is an example of an image forming apparatus, an MFP 110, a personal computer (PC) 111, and a facsimile 113.

The MFP 100 includes a reading device 101, an image processing unit 102, a central processing unit (CPU) 103, a memory 104, a storage device 105, an editing processing unit 106, a writing device 107, a post-processing unit 108, a network interface unit 109, a modem 112, an operating unit 114, and a display unit 115.

The reading device 101 reads a document to acquire electronic image data (input image data). The writing device 107 prints the image data on a transfer sheet. The CPU 103 controls various types of processing performed in the MFP 100. The memory 104 temporarily stores therein the image data received via the CPU 103 through a bus. The storage device 105 stores therein the image data. The image processing unit 102 performs image processing (for example, processing relating to image quality) on the read image data. The editing processing unit 106 performs editing operation (for example, processing not relating to image quality) such as adjusting a binding margin, combining pages, and duplex printing.

The network interface unit 109 transmits and receives the image data to and from external devices such as the MFP 110 and the PC 111 via a network line. The modem 112 transmits and receives the image data to and from external devices such as the facsimile 113 via a telephone line. The operating unit 114 sets setting information such as image processing setting for the image processing performed by the image processing unit 102, editing setting for the edition performed by the editing processing unit 106, and post-processing setting for the post-processing performed by the post-processing unit 108. The display unit 115 displays a preview of the image data and the setting information set by the operating unit 114. The post-processing unit 108 performs post-processing such as punching and stapling on the transfer sheet on which the image data has been printed in the writing device 107.

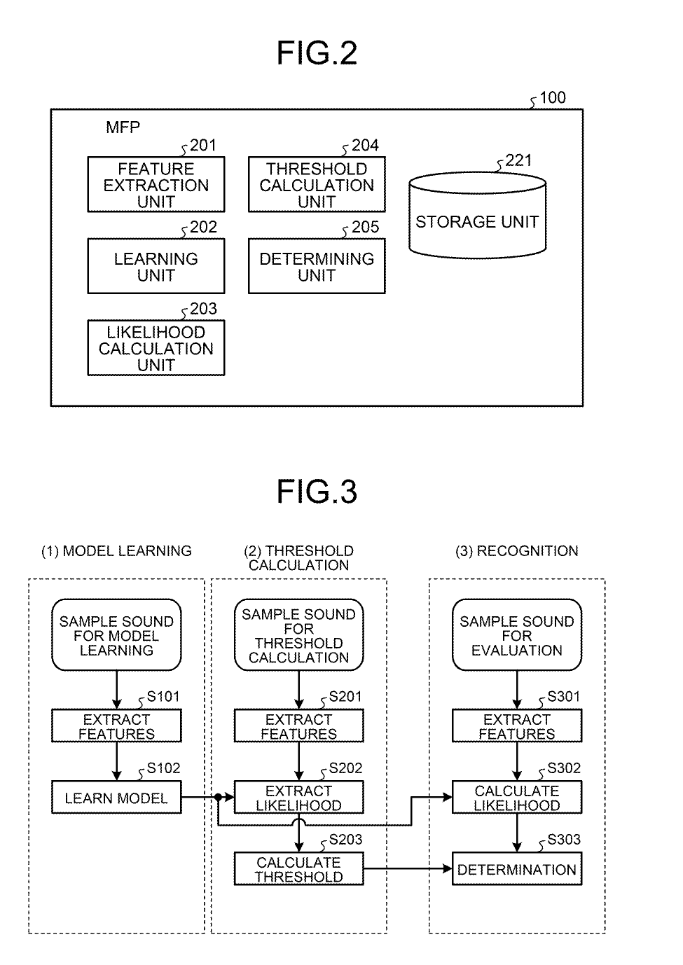

FIG. 2 is a block diagram illustrating an example of a functional configuration of the MFP 100. As illustrated in FIG. 2, the MFP 100 includes a storage unit 221, a feature extraction unit 201, a learning unit 202, a likelihood calculation unit 203, a threshold calculation unit 204, and a determining unit 205.

The storage unit 221 stores therein data used for the processing in the MFP 100. The storage unit 221 stores, for example, learned data used for the learning operation performed by the learning unit 202, and models generated in the learning operation. The storage unit 221 corresponds to, for example, the memory 104 and the storage device 105 illustrated in FIG. 1. The storage unit 221 can be of any type of commercially available storage medium such as a hard disk drive (HDD), an optical disk, a memory card, and a random access memory (RAM).

The feature extraction unit 201 extracts features from sample sound. As the features of sound, any type of features can be used such as energy, frequency spectrum, and mel-frequency cepstrum coefficients (MFCC) that have been conventionally used as the features.

The learning unit 202 learns, on the basis of learned data of abnormal sound (first pattern), a model for determining whether recognition object sound data (recognition object data) input to the pattern recognition system is abnormal sound. Normally, abnormal sound also has a plurality of variations. Thus, the learning unit 202 learns a model by using a plurality of pieces of learned data of abnormal sound that is each classified into any one of a plurality of categories of abnormal sound. In the first embodiment, the learning unit 202 does not learn a model by using learned data of normal sound.

The learning method used by the learning unit 202 and the form of a model to be learned may be any method and any form. For example, the learning unit 202 can learn a model such as a Gaussian mixture model (GMM) and a hidden Markov model (HMM) by using a learning method corresponding to the model.

In the first embodiment, features are the learned data. For example, the learning unit 202 can learn a model of abnormal sound by using features extracted in advance from abnormal sound as learned data. When abnormal sound data can be obtained in advance, the learning unit 202 may perform learning operation by using features extracted from the abnormal sound data by the feature extraction unit 201 as learned data.

The likelihood calculation unit 203 calculates likelihood indicating how likely it is that sound data input to the pattern recognition system is abnormal sound by using the learned model. The likelihood calculation unit 203 calculates likelihood by using a calculation method determined in accordance with a model applied to the pattern recognition system. When a GMM is used, the likelihood calculation unit 203 can calculate the likelihood of features by using the same method as used in the technology disclosed in Aiba et al., described above.

The threshold calculation unit 204 calculates a threshold on the basis of likelihood (first likelihood) calculated with respect to learned data of abnormal sound and likelihood (second likelihood) calculated with respect to learned data of normal sound (second pattern). The threshold is compared with the likelihood to determine whether the recognition object data is abnormal sound. When abnormal sound is classified into a plurality of categories, the threshold calculation unit 204 may calculate the threshold for each category.

The determining unit 205 determines whether the recognition object data is abnormal sound by using the calculated threshold. The determining unit 205, for example, compares the likelihood calculated with respect to the recognition object data by the likelihood calculation unit 203 with the threshold calculated by the threshold calculation unit 204. When, for example, the likelihood is equal to or larger than the threshold, the determining unit 205 determines that the recognition object data is abnormal sound, and when the likelihood is smaller than the threshold, the determining unit 205 determines that the recognition object data is normal sound.

The feature extraction unit 201, the learning unit 202, the likelihood calculation unit 203, the threshold calculation unit 204, and the determining unit 205 may be implemented by, for example, causing a processor such as the CPU 103 to execute a computer program, in other words, implemented by software, may be implemented by hardware such as an integrated circuit (IC), or may be implemented by using both software and hardware.

Described next is the operations performed by the MFP 100 according to the first embodiment as configured as described above with reference to FIG. 3. FIG. 3 is a flowchart illustrating an example of the learning operation, the threshold calculation operation, and the recognition operation according to the first embodiment. As illustrated in FIG. 3, the MFP 100 according to the first embodiment performs three types of operations: (1) the learning operation in which a model is learned in advance; (2) the threshold calculation operation in which a threshold is calculated in advance by using the learned model; and (3) the recognition operation in which a pattern is recognized by using the model and the threshold.

Described first is (1) the learning operation. The feature extraction unit 201 of the MFP 100 receives sample sound for model learning and extracts features of the sample sound (S101). The learning unit 202 learns a model by using the extracted features (S102).

The sample sound for model learning is abnormal sound. When a plurality of categories (kinds, variations) of abnormal sound exist, the feature extraction unit 201 calculates features by using sample sounds corresponding to the respective categories of abnormal sound to be recognized and the learning unit 202 learns as many models.

Described next is (2) the threshold calculation operation. The feature extraction unit 201 of the MFP 100 receives sample sound for threshold calculation, and extracts features of the sample sound (S201). The sample sound for threshold calculation includes both normal sound and abnormal sound. Sample sound of abnormal sound may be the same sample sound as used in the model learning operation, or may be different sound.

The likelihood calculation unit 203 uses the model acquired in the learning operation and the features extracted at S201 to calculate the likelihood of the features in the model (S202). The threshold calculation unit 204 calculates a threshold by using the calculated likelihood (S203).

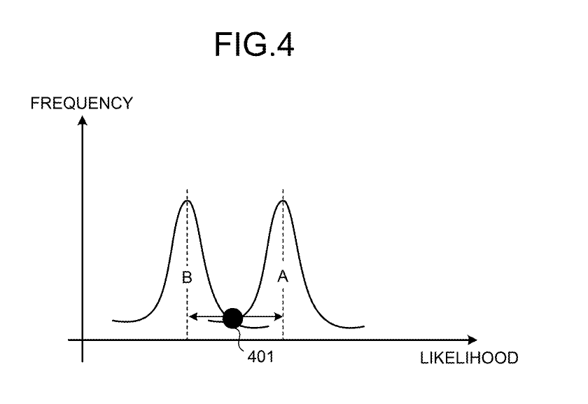

FIG. 4 is a diagram illustrating an example of the threshold calculation operation. FIG. 4 illustrates distribution of likelihood with the horizontal axis representing likelihood, and the vertical axis representing frequency. Distribution A is the distribution of likelihood calculated from the features of abnormal sound. Distribution B is the distribution of likelihood calculated from the features of normal sound. FIG. 4 illustrates an example of distribution of likelihood with respect to abnormal sound of a certain category. When a plurality of categories of abnormal sound exists, each category can have its own distribution.

The threshold calculation unit 204 may calculate, based on the distribution described above, a value between the peak value (a value of likelihood of abnormal sound having the highest frequency) of the distribution A and the peak value (a value of likelihood of normal sound having the highest frequency) of the distribution B as a threshold. For example, the threshold calculation unit 204 calculates a value of likelihood corresponding to an intersection 401 (a Bayes boundary) of the distribution A and the distribution B as a threshold.

The threshold calculation unit 204 may calculate a value of the intersection 401 as a temporary threshold, and change the temporary threshold in accordance with, for example, a specification by a user to obtain the final threshold. For example, the threshold calculation unit 204 calculates a value specified by the user among values between the peak value of the distribution A and the peak value of the distribution B, as a threshold. The value may be specified in any method. For example, the threshold calculation unit 204 may be configured to calculate a value directly specified by the user as a threshold. The user can specify a value of the threshold through, for example, the operating unit 114.

The threshold calculation unit 204 may be configured to calculate a threshold in accordance with detection sensitivity of abnormal sound specified by the user. For example, when the user specifies that detection sensitivity be increased, the threshold calculation unit 204 calculates a value smaller than the value of the temporary threshold as a threshold. This configuration makes it more possible that the recognition object data is recognized as abnormal sound. When the user specifies that the detection sensitivity be reduced, the threshold calculation unit 204 calculates a value larger than the value of the temporary threshold as a threshold. This configuration makes it less possible that the recognition object data is recognized as abnormal sound.

The threshold calculation unit 204 may be configured to calculate a threshold in accordance with a degree of danger of abnormal sound specified by the user. For example, when the user specifies that the degree of danger is high, the threshold calculation unit 204 calculates a value smaller than the value of the temporary threshold as a threshold. This configuration makes it more possible that the recognition object data is recognized as abnormal sound. If a certain kind of sound is abnormal sound with a high degree of danger, the MFP 100 is configured to highly possibly detect the sound as abnormal sound, whereby the MFP 100 can detect the sound as abnormal sound without fail.

When the user specifies that the degree of danger is low, the threshold calculation unit 204 calculates a value larger than the value of the temporary threshold as a threshold. This configuration makes it less possible that the recognition object data is recognized as abnormal sound.

As described above, the pattern recognition system according to the first embodiment generates a model by using only the learned data of abnormal sound, and calculates a threshold of likelihood for determining whether the recognition object data is abnormal sound, by using learned data of normal sound and abnormal sound. In calculating the threshold, for example, distribution of likelihood and user's specification are considered, so that the pattern recognition system can calculate a more suitable value as a threshold. With this configuration, the pattern recognition system can improve the accuracy of recognition using a threshold.

With reference to FIG. 3 again, described next is (3) the recognition operation. The feature extraction unit 201 of the MFP 100 receives sample sound to be evaluated (recognition object sound) and extracts features of the sample sound (S301). The sample sound to be evaluated is unknown sound as to whether it is normal sound or abnormal sound.

The likelihood calculation unit 203 uses the model acquired in the learning operation and the features extracted at S301 to calculate the likelihood of the features in the model (S302). The determining unit 205 compares the calculated likelihood with the threshold calculated in advance in the threshold calculation operation to determine whether the received sample sound is abnormal sound (S303).

If a plurality of categories of abnormal sound exists, the determining unit 205 first classifies the sample sound into a category of abnormal sound having the highest likelihood. The determining unit 205 compares the threshold calculated for the category with the likelihood calculated with respect to the sample sound that is recognition object sound at S302. If the likelihood is equal to or larger than the threshold, the determining unit 205 determines that the recognition object sound is abnormal sound in the category into which the sound is classified. If the likelihood is smaller than the threshold, the determining unit 205 determines that the recognition object sound is normal sound.

As described above, the pattern recognition system according to the first embodiment does not learn a model by using normal sound that has many variations, but learns a model by using only abnormal sound. The pattern recognition system generates as many models as the number of variations of abnormal sound that the user needs to recognize by learning the variations of abnormal sound in advance. The pattern recognition system according to the first embodiment calculates a threshold for distinguishing abnormal sound from normal sound for each model of abnormal sound. In the recognition operation, normal sound is temporarily categorized into a model of abnormal sound having the highest likelihood. Subsequently, the absolute value of the likelihood is compared with the threshold set in advance, so that the normal sound is excluded from the category of abnormal sound (the normal sound is determined to be normal sound). By this method, normal sound and abnormal sound can be highly accurately distinguished from each other even when the feature of the normal sound and the feature of the abnormal sound are similar to each other, or even when weak abnormal sound is mixed into normal sound.

### Second Embodiment

In the first embodiment, for example, when abnormal sound of a certain kind (category) is added to the pattern recognition system, each MFP needs to perform the learning operation and the other operations over again by using sample sound of abnormal sound in the category to be added to the pattern recognition system. In a pattern recognition system according to a second embodiment, the learning operation, the threshold calculation operation, and the recognition operation are performed in a server, not in MFPs. With this configuration, the learning operation and the other operations need not be performed in each MFP, whereby processing load can be reduced.

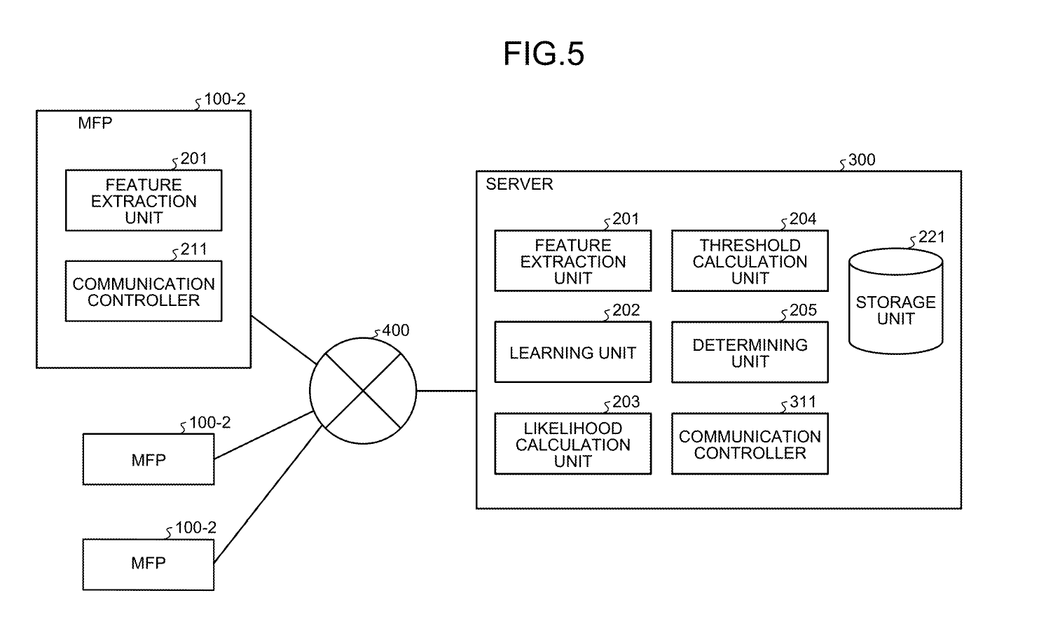

FIG. 5 is a block diagram illustrating an example of a pattern recognition system according to the second embodiment. As illustrated in FIG. 5, the pattern recognition system is configured with a plurality of MFPs 100-2 and a server 300 that are connected with each other via a network 400. The number of the MFPs 100-2 is not limited to three, but may be any number equal to or larger than one. The network 400 may be in any form of network such as the Internet or a local area network (LAN). The network 400 may be a wired network, or wireless network.

The server 300 is configured with a general-purpose PC, for example. The number of the server 300 is not limited to one. For example, the functions of the server 300 may be physically distributed into a plurality of devices, or a plurality of servers 300 having the same functions may be provided in the system.

An MFP 100-2 includes the feature extraction unit 201 and a communication controller 211. The server 300 includes the storage unit 221, the feature extraction unit 201, the learning unit 202, the likelihood calculation unit 203, the threshold calculation unit 204, the determining unit 205, and a communication controller 311.

The second embodiment differs from the first embodiment mainly in that the server 300 includes the functions of the MFP 100 according to the first embodiment, and the communication controllers 211 and 311 are added. The same reference signs are given to the units having the same functions as those illustrated in FIG. 2 that is the block diagram of the MFP 100 according to the first embodiment, and the description thereof is omitted.

The communication controller 211 of the MFP 100-2 controls transmission and reception of information to and from external devices such as the server 300. The communication controller 211 transmits, for example, features extracted by the feature extraction unit 201 of the MFP 100-2 to the server 300. The communication controller 211 receives a determination result of the transmitted features determined by the server 300 (determining unit 205).

The communication controller 311 of the server 300 controls transmission and reception of information to and from external devices such as the MFPs 100-2. The communication controller 311 receives, for example, features transmitted from the communication controller 211 of an MFP 100-2. The communication controller 311 transmits a determination result of the received features determined by the determining unit 205 to the MFP 100-2.

The learning operation and the threshold calculation operation according to the second embodiment are the same as those in the first embodiment (FIG. 3), except that the place where the learning operation and the threshold calculation operation are performed is changed to the server 300. The recognition operation according to the second embodiment differs from that of the first embodiment in that the calculation of features (S301) is performed by the MFP 100-2 (the feature extraction unit 201), and calculation of likelihood (S302) and determination (S303) are performed by the server 300 (the likelihood calculation unit 203 and the determining unit 205).

Specifically, in the second embodiment, the MFP 100-2 performs operations up to the extraction of features of recognition object sound. The extracted features are transmitted by the communication controller 211 to the server 300. The MFP 100-2 may be configured to transmit the recognition object sound to the server 300, and the server 300 may be configured to perform the extraction of features and its subsequent operations. In this case, the MFP 100-2 may be configured to transmit encrypted sound information to the server 300 so that the sound information will not be transferred in the network 400 as it is.

As described above, in the pattern recognition system according to the second embodiment, the server 300 can perform the learning operation, the threshold calculation operation and the recognition operation. With this configuration, for example, when abnormal sound of a new kind (category) is added to the pattern recognition system, it is sufficient to perform the learning operation and other operations only in the server 300 again. Consequently, processing load can be reduced and system update such as addition of a new kind of abnormal sound can be expeditiously performed.

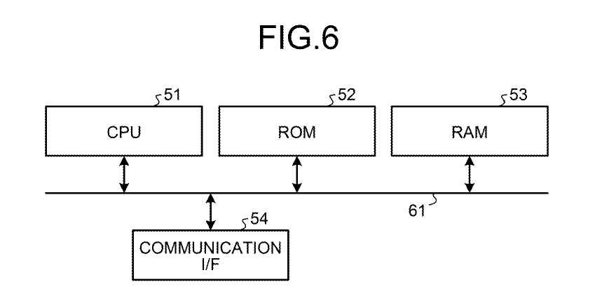

Described next is a hardware configuration of the server 300 according to the second embodiment with reference to FIG. 6. FIG. 6 is a diagram illustrating the hardware configuration of the server 300 according to the second embodiment.

The server 300 according to the second embodiment includes a controller such as a CPU 51, a storage device such as a read only memory (ROM) 52 and a random access memory (RAM) 53, a communication I/F 54 that performs communication by connecting to a network, an external storage device such as an HDD and a compact disc (CD) drive, a display device such as a display, an input device such as a keyboard and a mouse, and a bus that connects these devices. The server 300 is configured with a general-purpose computer to implement the hardware configuration.

A computer program executed on the server 300 according to the second embodiment is recorded and provided, as a computer program product, in a computer-readable recording medium such as a compact disc read only memory (CD-ROM), a flexible disk (FD), a compact disc recordable (CD-R), and a digital versatile disc (DVD), as an installable or executable file.

The computer program executed on the server 300 according to the second embodiment may be stored in a computer connected to a network such as the Internet and provided by being downloaded via the network. Furthermore, the computer program executed on the server 300 according to the second embodiment may be provided or distributed via a network such as the Internet.

The computer program according to the second embodiment may be embedded and provided in a ROM, for example.

The computer program executed on the server 300 according to the second embodiment is configured with modules including the units described above. As actual hardware, the CPU 51 (processor) reads out the computer program from the storage medium described above and executes the computer program, and the above described units are loaded on a main storage device and generated on the main storage device.

The present invention can achieve high accuracy pattern recognition.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A pattern recognition system comprising:
a learning unit to learn, based on learned data of a first pattern, a model for determining whether recognition object data is the first pattern;
a likelihood calculation unit to calculate likelihood indicating how likely the recognition object data is the first pattern by using the model learned by the learning unit;
a threshold calculation unit to calculate a threshold to be compared with the likelihood to determine whether the recognition object data is the first pattern, based on first likelihood that is calculated with respect to learned data of the first pattern and second likelihood that is calculated with respect to learned data of a second pattern; and
a determining unit to determine whether the recognition object data is the first pattern by using the threshold.

2. The pattern recognition system according to claim 1, wherein
the learning unit learns the model based on a plurality of pieces of learned data of the first pattern classified into any one of a plurality of categories, and
the threshold calculation unit calculates the threshold for each of the categories.

3. The pattern recognition system according to claim 1, wherein the threshold calculation unit calculates the threshold having a value between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

4. The pattern recognition system according to claim 1, wherein the threshold calculation unit calculates the threshold having a value of an intersection of distribution of a plurality of values of first likelihood calculated with respect to a plurality of pieces of learned data of the first pattern and distribution of a plurality of values of second likelihood calculated with respect to a plurality of pieces of learned data of the second pattern.

5. The pattern recognition system according to claim 1, wherein the threshold calculation unit calculates the threshold having a specified value among values between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

6. The pattern recognition system according to claim 1, wherein
the first pattern is a pattern of abnormal sound,
the second pattern is a pattern of normal sound, and
the threshold calculation unit calculates the threshold having a value determined in accordance with detection sensitivity specified as sensitivity in detecting the abnormal sound, among values between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

7. The pattern recognition system according to claim 1, wherein
the first pattern is a pattern of abnormal sound,
the second pattern is a pattern of normal sound, and
the threshold calculation unit calculates the threshold having a value determined in accordance with a degree of danger specified as a degree of danger of the abnormal sound, among values between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

8. A computer program product comprising a non-transitory computer-readable medium including programmed instructions, the instructions causing a computer to function as:
a learning unit to learn, based on learned data of a first pattern, a model for determining whether recognition object data is the first pattern;
a likelihood calculation unit to calculate likelihood indicating how likely the recognition object data is the first pattern by using the model learned by the learning unit;
a threshold calculation unit to calculate a threshold to be compared with the likelihood to determine whether the recognition object data is the first pattern, based on first likelihood that is calculated with respect to learned data of the first pattern and second likelihood that is calculated with respect to learned data of a second pattern; and
a determining unit to determine whether the recognition object data is the first pattern by using the threshold.

9. The computer program product according to claim 8, wherein
the learning unit learns the model based on a plurality of pieces of learned data of the first pattern classified into any one of a plurality of categories, and
the threshold calculation unit calculates the threshold for each of the categories.

10. The computer program product according to claim 8, wherein the threshold calculation unit calculates the threshold having a value between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

11. The computer program product according to claim 8, wherein the threshold calculation unit calculates the threshold having a value of an intersection of distribution of a plurality of values of first likelihood calculated with respect to a plurality of pieces of learned data of the first pattern and distribution of a plurality of values of second likelihood calculated with respect to a plurality of pieces of learned data of the second pattern.

12. The computer program product according to claim 8, wherein the threshold calculation unit calculates the threshold having a specified value among values between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

13. The computer program product according to claim 8, wherein
the first pattern is a pattern of abnormal sound,
the second pattern is a pattern of normal sound, and
the threshold calculation unit calculates the threshold having a value determined in accordance with detection sensitivity specified as sensitivity in detecting the abnormal sound, among values between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

14. The computer program product according to claim 8, wherein
the first pattern is a pattern of abnormal sound,
the second pattern is a pattern of normal sound, and
the threshold calculation unit calculates the threshold having a value determined in accordance with a degree of danger specified as a degree of danger of the abnormal sound, among values between a first value and a second value, the first value having highest frequency of a plurality of values of first likelihood calculated with respect to a plurality of pieces of learned data of the first pattern, and the second value having highest frequency of a plurality of values of second likelihood calculated with respect to a plurality of pieces of learned data of the second pattern.

15. A pattern recognition method comprising:
learning, based on learned data of a first pattern, a model for determining whether recognition object data is the first pattern;
calculating likelihood indicating how likely the recognition object data is the first pattern by using the model learned in the learning;
calculating a threshold to be compared with the likelihood to determine whether the recognition object data is the first pattern, based on first likelihood that is calculated with respect to learned data of the first pattern and second likelihood that is calculated with respect to learned data of a second pattern; and
determining whether the recognition object data is the first pattern by using the threshold.
